(19) United States
(12) Patent Application Publication
(10) Pub. No.: US 2026/0043118 A1
(43) Pub. Date: Feb. 12, 2026

(54) MANUFACTURING METHOD OF ALUMINUM-COATED STEEL SHEET, ALUMINUM-PLATED STEEL SHEET, AND HOT STAMPING PRODUCT

(71) Applicants: HYUNDAI MOTOR COMPANY, SEOUL (KR); KIA CORPORATION, SEOUL (KR); HYUNDAI STEEL COMPANY, INCHEON (KR)

(72) Inventors: Hyuckmin Kwon, Hwaseong-si (KR); Seongguk Son, Hwaseong-si (KR); Seon Jin Kim, Ansan-si (KR); Seong Min So, Dangjin-si (KR); Jae Min Lee, Gimpo-si (KR)

(73) Assignees: HYUNDAI MOTOR COMPANY, SEOUL (KR); KIA CORPORATION, SEOUL (KR); HYUNDAI STEEL COMPANY, INCHEON (KR)

(21) Appl. No.: 19/012,048

(22) Filed: Jan. 7, 2025

(30) Foreign Application Priority Data
Aug. 9, 2024 (KR) 10-2024-0106650

(51) Int. Cl. C23C 2/12; B32B 15/01; C22C 21/02; C23C 2/40

(52) U.S. Cl. CPC C23C 2/12; B32B 15/012; C22C 21/02; C23C 2/40; B32B 2311/24

(57) ABSTRACT

A manufacturing method of an aluminum-coated steel sheet includes preparing aluminum (Al) scraps, manufacturing an ingot using the Al scraps, coating a base steel using the ingot, and processing a coated steel sheet. An aluminum-coated steel sheet includes a base steel, and a coating layer formed on the base steel, and the coating layer may contain 8.9 to 9.6 wt % of Si, 1.3 wt % or lower of Fe, 0.7 wt % or lower of Mg, the remainder Al, and other unavoidable impurities.

### CROSS REFERENCE TO RELATED APPLICATIONS

This present application claims the benefit of priority to Korean Patent Application No. 10-2024-0106650, filed on Aug. 9, 2024, in the Korean Intellectual Property Office, the entire disclosure of which is incorporated herein by reference.

### FIELD

The present disclosure relates to a manufacturing method of an aluminum-coated steel sheet, an aluminum-coated steel sheet, and a hot stamping product.

### BACKGROUND

As nationally determined contributions (NDC) of the world's major countries are raised, the development of carbon-reducing products is demanded.

Further, demands for hot stamping materials are increasing due to increased crash safety regulations and the need for improved fuel efficiency. As the hot stamping materials, Al—Si coating is mainly used among Al-based coatings, due to its high heat resistance and corrosion resistance effect through dense oxide formation.

According to International Aluminum Institution, generally, Al uses a lot of electricity and heat energy during smelting, resulting in high carbon emissions. Specifically, Al undergoes a complex smelting process called “Bauxite mining-Alumina refining-Anode production-Aluminum smelting-Primary casting”, to generate a lot of carbon emissions.

### SUMMARY

An aspect of the present disclosure is to provide a manufacturing method of an aluminum-coated steel sheet using aluminum (Al) scraps. Another aspect of the present disclosure is to provide an aluminum-coated steel sheet and a hot stamping product having a physical property equivalent to or better than that of the existing products.

A manufacturing method of an aluminum-coated steel sheet according to an exemplary embodiment of the present disclosure comprises preparing a plurality of aluminum (Al) scraps, manufacturing an ingot using the plurality of Al scraps, coating a base steel using the ingot, and a processing a coated steel sheet.

In the manufacturing method of an aluminum-coated steel sheet according to an exemplary embodiment of the present disclosure, the plurality of Al scraps may contain 9.6 wt % or lower of Si, 1.5 wt % or lower of Fe, 0.9 wt % or lower of Mg, a remainder Al, and other unavoidable impurities.

In the manufacturing method of an aluminum-coated steel sheet according to an exemplary embodiment of the present disclosure, the step of manufacturing the ingot comprises: melting a plurality of Al scraps, and refining the plurality of Al scraps.

In the manufacturing method of an aluminum-coated steel sheet according to an exemplary embodiment of the present disclosure, in the manufacturing of the ingot, the ingot containing 8.9 to 9.6 wt % of Si, 1.3 wt % or lower of Fe, 0.7 wt % or lower of Mg, the remainder Al, and other unavoidable impurities is manufactured

In the manufacturing method of an aluminum-coated steel sheet according to an exemplary embodiment of the present disclosure, the coating of the base steel comprises thermally treating the base steel, immersing the base steel in a coating bath, and cooling a coated steel sheet, and the coating bath is manufactured from the ingot.

In the manufacturing method of an aluminum-coated steel sheet according to an exemplary embodiment of the present disclosure, the coating bath may contain 8.9 to 9.6 wt % of Si, 1.3 wt % or lower of Fe, 0.7 wt % or lower of Mg, a remainder Al, and other unavoidable impurities.

In the manufacturing method of an aluminum-coated steel sheet according to an exemplary embodiment of the present disclosure, thermally treating the base steel is performed at a temperature of 700° C. to 850° C.

In the manufacturing method of an aluminum-coated steel sheet according to an exemplary embodiment of the present disclosure, the temperature of the coating bath is from 630° C. to 680° C.

In the manufacturing method of an aluminum-coated steel sheet according to an exemplary embodiment of the present disclosure, the cooling is performed at a cooling rate of 3° C./s to 20° C./s.

In the manufacturing method of an aluminum-coated steel sheet according to an exemplary embodiment of the present disclosure, during processing of the coated steel sheet, hot stamping is performed on the coated steel sheet.

In the manufacturing method of an aluminum-coated steel sheet according to an exemplary embodiment of the present disclosure, processing of the coated steel sheet is performed at a temperature of 860° C. to 960° C.

A manufacturing method of an aluminum-coated steel sheet according to an exemplary embodiment of the present disclosure comprises preparing an ingot containing 8.9 to 9.6 wt % of Si, 1.3 wt % or lower of Fe, 0.7 wt % or lower of Mg, a remainder Al, and other unavoidable impurities; and coating a base steel using the ingot.

In the manufacturing method of an aluminum-coated steel sheet according to an exemplary embodiment of the present disclosure, the ingot is manufactured from Al scraps.

In the manufacturing method of an aluminum-coated steel sheet according to an exemplary embodiment of the present disclosure, the Al scrap ingot contain 9.6 wt % or lower of Si, 1.5 wt % or lower of Fe, 0.9 wt % or lower of Mg, a remainder Al, and other unavoidable impurities.

An aluminum-coated steel sheet according to an exemplary embodiment of the present disclosure may be manufactured from the above-described manufacturing method.

An aluminum-coated steel sheet according to an exemplary embodiment of the present disclosure includes a base steel; and a coating layer formed on the base steel, and the coating layer may contain 8.9 to 9.6 wt % of Si, 1.3 wt % or lower of Fe, 0.7 wt % or lower of Mg, the remainder Al, and other unavoidable impurities.

In the aluminum-coated steel sheet according to an exemplary embodiment of the present disclosure, the other unavoidable impurities are included in an amount of 0.2 wt % or lower.

In the aluminum-coated steel sheet according to an exemplary embodiment of the present disclosure, the coating layer is formed from an aluminum (Al) scrap ingot.

In the aluminum-coated steel sheet according to an exemplary embodiment of the present disclosure, the Al scrap may contain 9.6 wt % or lower of Si, 1.5 wt % or lower of Fe, 0.9 wt % or lower of Mg, the remainder Al, and other unavoidable impurities.

A hot stamping product according to an exemplary embodiment of the present disclosure comprises the above-described aluminum-coated steel sheet.

According to the manufacturing method of an aluminum-coated steel sheet according to various exemplary embodiments of the present disclosure, a coated steel sheet is manufactured using recycled Al scraps, thereby omitting the complex Al smelting process of the related art. Accordingly, an amount of electric energy and thermal energy used for the Al smelting is lowered to achieve low carbon emission factor and is environmentally friendly.

According to the manufacturing method of an aluminum-coated steel sheet according to various exemplary embodiments of the present disclosure, an aluminum-coated steel sheet having a physical property equivalent to or better than that of the Al—Si coated steel sheet of the related art can be manufactured.

The aluminum-coated steel sheet according to various exemplary embodiments of the present disclosure has a physical property equivalent to or better than that of the Al—Si coated steel sheet of the related art. The aluminum-coated steel sheet according to various exemplary embodiments of the present disclosure has a coating quality equivalent to or better than that of the hot stamping steel sheet of the related art. For example, the aluminum-coated steel sheet according to various exemplary embodiments of the present disclosure has a corrosion resistance and weldability equivalent to or better than those of the hot stamping steel sheet of the related art.

The hot stamping product according to various exemplary embodiments of the present disclosure has a physical property equivalent to or better than that of the hot stamping product of the related art. The hot stamping product according to various exemplary embodiments of the present disclosure has a coating quality equivalent to or better than that of the hot stamping product of the related art. For example, the hot stamping product according to various exemplary embodiments of the present disclosure has a corrosion resistance and weldability equivalent to or better than those of the hot stamping product of the related art.

The effects of the present disclosure are not limited to those mentioned above, and other effects not mentioned can be clearly understood by those skilled in the art from the following description.

### BRIEF DESCRIPTION OF THE FIGURES

The foregoing and other aspects, features, and advantages of the invention, as well as the following detailed description of the embodiments, will be better understood when read in conjunction with the accompanying drawings. For the purpose of illustrating the present disclosure, there is shown in the drawings an exemplary embodiment, it being understood, however, that the present disclosure is not intended to be limited to the details shown because various modifications and structural changes may be made therein without departing from the spirit of the present disclosure and within the scope and range of equivalents of the claims. The use of the same reference numerals or symbols in different drawings indicates similar or identical items.

FIG. 1 is a process flowchart of a manufacturing method of an aluminum-coated steel sheet according to various exemplary embodiments of the present disclosure;

FIG. 2 is a view for an apparatus for manufacturing an aluminum-coated steel sheet according to various exemplary embodiments of the present disclosure;

FIG. 3 is a photograph of a surface of an aluminum-coated steel sheet manufactured according to Comparative Example;

FIG. 4 is a photograph of a surface an aluminum-coated steel sheet manufactured according to Example 1; and

FIG. 5 is a photograph of a surface an aluminum-coated steel sheet manufactured according to Example 2.

### DETAILED DESCRIPTION

Hereinafter, an exemplary embodiment disclosed in the present specification will be described in detail with reference to the accompanying drawings in detail. In the following description, the same or similar components are denoted by the same or similar reference numerals and a redundant description thereof may be omitted.

In this specification, the terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof.

### Manufacturing Method of Aluminum-Coated Steel Sheet

Various exemplary embodiments of the present disclosure relate to a manufacturing method of an aluminum-coated steel sheet. Various exemplary embodiments of the present disclosure relate to a manufacturing method of an Al—Si coated steel sheet. Various exemplary embodiments of the present disclosure relate to a manufacturing method of a coated steel sheet for hot stamping.

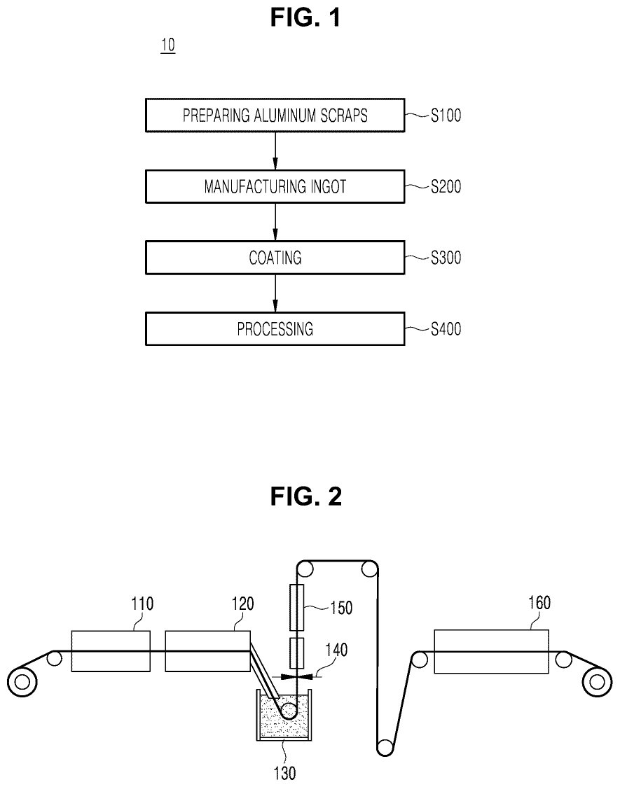

FIG. 1 is a process flowchart of a manufacturing method of an aluminum-coated steel sheet according to various exemplary embodiments of the present disclosure. FIG. 2 is a view for an apparatus for manufacturing an aluminum-coated steel sheet according to various exemplary embodiments of the present disclosure.

The manufacturing method 10 of an aluminum-coated steel sheet according to various exemplary embodiments of the present disclosure may be performed by an apparatus illustrated in FIG. 2.

Referring to FIG. 1, the manufacturing method 10 of an aluminum-coated steel sheet according to various exemplary embodiments of the present disclosure comprises a step S100 of preparing aluminum (Al) scraps, a step S200 of manufacturing an ingot, a coating step S300, and a processing step S400.

In the step S100 of preparing Al scraps, recycled Al (secondary Al) scraps may be collected. According to the manufacturing method of an aluminum-coated steel sheet according to various exemplary embodiments of the present disclosure, a coated steel sheet is manufactured using recycled Al scraps, thereby omitting the complex Al smelting process of the related art. Accordingly, an amount of electric energy and thermal energy used for the Al smelting is lowered to achieve low carbon emission factor and is environmentally friendly.

The Al scraps may contain 9.6 wt % or lower of Si, 1.5 wt % or lower of Fe, 0.9 wt % or lower of Mg, the remainder Al, and other unavoidable impurities. Other unavoidable impurities contain at least any one of Cu, Mn, Cr, Zn, Ni, Ti, Pb, and Sn. Other unavoidable impurities are included in an amount of 0.2 wt % or lower. When the Al scraps have the corresponding wt %, during the process of collecting the Al scraps, the Al scraps may be smoothly provided. Further, a coating quality equivalent to or better than the existing Al—Si coating is ensured, and deterioration of operability is minimized.

To be more specific, when a Si content of the Al scraps exceeds 9.6%, an Si content of an ingot which will be manufactured later may exceed 9.6% and alloying of Al and Fe may be suppressed during the coating using the ingot.

When a Fe content of the Al scraps exceeds 1.5%, if the ingot is put into a coating bath, dross is excessively formed due to the Fe—Al reaction, which may be detrimental to operation.

When a Mg content of the Al scraps exceeds 0.9%, a Mg content of the ingot is increased and oxide dross due to the Mg oxidation is excessively formed during the coating using the ingot. In addition, the blackening phenomenon due to the enrichment of the Mg surface layer in the coating material may be aggravated.

The step S200 of manufacturing an ingot comprises melting Al scarps and refining.

In the step of melting Al scraps, Al scraps prepared in the step S100 of preparing Al scraps are melted. Next, the refining step is performed using the melted Al scraps. An Al—Si ingot for hot dipping coating may be manufactured by the step of melting Al scraps and the refining step.

The step S200 of manufacturing an ingot comprises controlling an Si content of the ingot. In the step S200 of manufacturing an ingot, an Si content of the ingot is adjusted to 8.9 to 9.6 wt %. By doing this, the Fe content of the ingot is lowered to 1.3 wt % or lower and the Mg content is lowered to 0.7 wt %. That is, the ingot manufactured in the step S200 of manufacturing an ingot contains 8.9 to 9.6 wt % of Si, 1.3 wt % or lower of Fe, 0.7 wt % or lower of Mg, the remainder Al, and other unavoidable impurities. Other unavoidable impurities include at least any one of Cu, Mn, Cr, Zn, Ni, Ti, Pb, and Sn. Other unavoidable impurities are included in an amount of 0.2 wt % or lower.

In the meantime, if the Si content of the ingot is lower than 8.9%, the corrosion resistance of the coating may be reduced due to excessive alloying. If the Si content of the ingot is higher than 9.6%, adhesion between the base steel and the coating may be reduced due to alloying inhibition.

Next, the coating step S300 is performed.

The coating step S300 may comprise thermally treating the base steel, immersing the base steel in a coating bath, and cooling the coated steel sheet.

In the meantime, prior to the thermally treating the base steel, washing the base steel may be further comprised. In the washing step, the base steel is prepared and then washed. At this time, the base steel may be a cold rolled steel sheet. The base steel may contain 0.15 wt % of carbon, 0.01 wt % of silicon (Si), 0.6 wt % of manganese (Mn), 0.05 wt % of phosphorus (P), 0.05 wt % of sulfur (S), and the remainder may contain iron (Fe) and impurities that are inevitably included in the steelmaking process. However, the composition and the content of the base steel are illustrative, and the technical spirit of the present disclosure is not limited thereto.

In the step of washing the base steel, after immersing the base steel in an alkaline solution at 40 to 60° C. for 10 to 50 minutes, the base steel is washed with water to remove foreign materials and oil on the surface.

In the thermally treating the base steel, the base steel is annealed. The thermally treating the base steel is performed at a temperature of 700 to 850° C. The thermal treatment is performed at the temperature in the corresponding range to ensure the physical property of the base steel. For example, when the thermal treatment temperature is lower than 700° C., the ductility may be low because sufficient recrystallization is not achieved in the base steel. When the thermal treatment temperature is higher than 850° C., it may be difficult to ensure sufficient tensile strength.

Next, in the immersing the base steel in the coating bath, the base steel is immersed in the coating bath manufactured from the ingot to perform the coating. The coating bath may be manufactured by melting the ingot which is previously manufactured. That is, the coating bath may be manufactured by melting the ingot which is manufactured from the Al scraps. Further, the coating bath may be manufactured by additionally mixing the existing Al—Si ingot, in addition to the ingot manufactured from the Al scraps.

The coating bath may contain 8.9 to 9.6 wt % of Si, 1.3 wt % or lower of Fe, 0.7 wt % or lower of Mg, the remainder Al, and other unavoidable impurities. Other unavoidable impurities include at least any one of Cu, Mn, Cr, Zn, Ni, Ti, Pb, and Sn. Other unavoidable impurities are included in an amount of 0.2 wt % or lower.

The temperature of the coating bath may be 630° C. to 680° C. If the temperature of the coating bath is lower than 630° C., the temperature changes due to the injection of the ingot so that the coating bath is hardened to degrade the fluidity. If the temperature of the coating bath is higher than 680° C., oxide dross may be generated by Mg and impurities generated from the Al scrap. Desirably, the temperature of the coating bath may be 640° C. to 670° C.

For example, the coating step S300 is performed using the apparatus illustrated in FIG. 2. Referring to FIG. 2, the ingot which is previously manufactured may be washed while passing through a washing unit 110. Next, the ingot is heated and melted while passing through a heating unit 120. The melted ingot forms the coating bath 130. After immersing the base steel in the coating bath 130, a coating amount may be controlled by allowing the melted coating solution on the base steel to pass through an air knife 140 which sprays high-pressure air.

Next, cooling the coated steel sheet, the coated base steel is cooled. At this time, the coated steel sheet is cooled while passing through a cooling unit 150 illustrated in FIG. 2. The cooling is performed at a cooling rate of 3° C./s to 20° C./s. If the cooing rate is lower than 3° C./s, coating which is not sufficiently hardened may be smeared onto a process roll and form excessive spangles. If the cooling rate is higher than 20° C./s, the coating layer is not uniform due to the cooling pressure. Desirably, the cooling rate may be 5° C./s to 15° C./s.

Next, in the processing step S400, the coated steel sheet may be processed. Specifically, referring to FIG. 2, the coated steel sheet may be processed while passing through a processing unit 160. For example, in the processing step S400, hot stamping is performed on the coated steel sheet. The hot stamping is a method of processing a high-strength steel that is hard to be processed in a mold press after heating it above the austenite temperature and performing softening heat treatment. Hot stamping can be used to manufacture automotive parts using ultra-high strength steel.

The processing step S400 is performed at a temperature of 860° C. to 960° C. If the thermal treatment temperature is lower than 860° C., it may be hard to process the coated steel sheet. If the thermal treatment temperature is higher than 960° C., the coating is excessively alloyed to cause coating crack, which results in degradation of corrosion resistance.

According to the manufacturing method of an aluminum-coated steel sheet according to various exemplary embodiments of the present disclosure, a coated steel sheet is manufactured using recycled Al scraps, thereby omitting the complex Al smelting process of the related art. Accordingly, an amount of electric energy and thermal energy used for the Al smelting is lowered to achieve low carbon emission factor and is environmentally friendly. According to the manufacturing method of an aluminum-coated steel sheet according to various exemplary embodiments of the present disclosure, an aluminum-coated steel sheet having a physical property which is equal to or higher than that of the Al—Si coated steel sheet of the related art can be manufactured.

### Aluminum-Coated Steel Sheet

An aluminum-coated steel sheet according to various exemplary embodiments of the present disclosure may be manufactured from the above-described manufacturing method. An aluminum-coated steel sheet according to various exemplary embodiments of the present disclosure may be a steel sheet for hot stamping. An aluminum-coated steel sheet according to various exemplary embodiments of the present disclosure may be an Al—Si based coated steel sheet.

The aluminum-coated steel sheet according to various exemplary embodiments of the present disclosure includes a base steel and a coating layer formed on the base steel, and the coating layer may contain 8.9 to 9.6 wt % of Si, 1.3 wt % or lower of Fe, 0.7 wt % or lower of Mg, the remainder Al, and other unavoidable impurities. Other unavoidable impurities include at least any one of Cu, Mn, Cr, Zn, Ni, Ti, Pb, and Sn. Other unavoidable impurities are included in an amount of 0.2 wt % or lower.

The coating layer may be formed from the ingot manufactured from the Al scraps. At this time, the Al scrap may contain 9.6 wt % or lower of Si, 1.5 wt % or lower of Fe, 0.9 wt % or lower of Mg, the remainder Al, and other unavoidable impurities. Other unavoidable impurities include at least any one of Cu, Mn, Cr, Zn, Ni, Ti, Pb, and Sn. Other unavoidable impurities are included in an amount of 0.2 wt % or lower.

The aluminum-coated steel sheet according to various exemplary embodiments of the present disclosure has a physical property equivalent to or better than that of the Al—Si coated steel sheet of the related art. The aluminum-coated steel sheet according to various exemplary embodiments of the present disclosure has a coating quality equivalent to or better than that of the hot stamping steel sheet of the related art. For example, the aluminum-coated steel sheet according to various exemplary embodiments of the present disclosure has a corrosion resistance and weldability equivalent to or better than those of the hot stamping steel sheet of the related art.

### Hot Stamping Product

The hot stamping product according to various exemplary embodiments of the present disclosure may comprise the above-described aluminum-coated steel sheet. The hot stamping product according to various exemplary embodiments of the present disclosure may comprise the Al—Si based coated steel sheet.

The hot stamping product according to various exemplary embodiments of the present disclosure comprises a base steel and a coating layer formed on the base steel and the coating layer may contain 8.9 to 9.6 wt % of Si, 1.3 wt % or lower of Fe, 0.7 wt % or lower of Mg, the remainder Al, and other unavoidable impurities. Other unavoidable impurities include at least any one of Cu, Mn, Cr, Zn, Ni, Ti, Pb, and Sn. Other unavoidable impurities are included in an amount of 0.2 wt % or lower.

The coating layer may be formed from the ingot manufactured from the Al scraps. At this time, the Al scrap may contain 9.6 wt % or lower of Si, 1.5 wt % or lower of Fe, 0.9 wt % or lower of Mg, the remainder Al, and other unavoidable impurities. Other unavoidable impurities include at least any one of Cu, Mn, Cr, Zn, Ni, Ti, Pb, and Sn. Other unavoidable impurities are included in an amount of 0.2 wt % or lower.

The hot stamping product according to various exemplary embodiments of the present disclosure has a physical property equivalent to or better than that of the hot stamping product of the related art. The hot stamping product according to various exemplary embodiments of the present disclosure has a coating quality equivalent to or better than that of the hot stamping product of the related art. For example, the hot stamping product according to various exemplary embodiments of the present disclosure has a corrosion resistance and weldability equivalent to or better than those of the hot stamping product of the related art.

Hereinafter, the present disclosure will be described in more detail through Examples. However, the following Examples and Experimental Examples are provided to describe the present disclosure in more detail, but the scope of the present disclosure is not limited by the following Example and Experimental Examples.

### EXAMPLES

The coating was performed using an ingot having compositions of the following Table 1. Examples 1 and 2 are coated steel sheets coated using the ingot using Al scraps. Comparative Example is a coated steel sheet coated using the Al—Si ingot of the related art.

TABLE 1

Ingot composition

| | Al | Si | Fe | Mg |
|---|---|---|---|---|
| Comparative Example | Bal. | 9.1 | 1.1 | 0.01↓ |
| Example 1 | | 8.921 | 0.153 | 0.3 |
| Example 2 | | 9.025 | 0.537 | 0.127 |

### Experimental Example 1: Observation of Surface of Coating

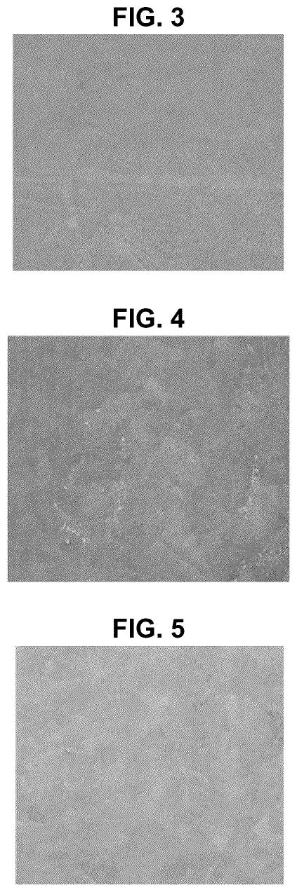

A surface of a coated steel sheet coated according to Comparative Example, Examples 1 and 2 was observed. FIG. 3 is a photograph of a surface of an aluminum-coated steel sheet manufactured according to Comparative Example. FIG. 4 is a photograph of a surface an aluminum-coated steel sheet manufactured according to Example 1. FIG. 5 is a photograph of a surface an aluminum-coated steel sheet manufactured according to Example 2.

Referring to FIGS. 3 to 5, it is understood that a surface of a coating of Examples 1 and 2, coated with an ingot using Al scraps, has excellent outer appearance. That is, when it is compared with the surface of the coating of Comparative Example coated with the Al—Si ingot of the related art, it is understood that the surface of the coating of Examples 1 and 2 has equivalent or better surface appearance.

### Experimental Example 2: Corrosion Resistance Check

In order to evaluate a corrosion resistance, the corrosion resistance was evaluated with a test method based on the salt spray test method (KS D 9502) according to the following criteria.
⊚: If the area of occurrence of red rust after 1000 hours is less than 5%
◯: If the area of occurrence of red rust after 1000 hours is 5 to 20%
x: If the area of occurrence of red rust after 1000 hours exceeds 20%

The results are the same as those of Table 2.

TABLE 2

| | Corrosion resistance |
|---|---|
| Comparative Example | ◯ |
| Example 1 | ⊚ |
| Example 2 | ⊚ |

As seen from Table 2, it was confirmed that the corrosion resistance of Examples 1 and 2 was excellent.

In the above, embodiments of the present disclosure were described with drawings. These are exemplary, and the present disclosure is not limited to the above-described embodiments and the contents of the drawings.

It will be apparent to those skilled in the art that the present disclosure can be modified within the scope of the disclosed technical idea. The described embodiments should be considered as a part of the present disclosure, and the scope of the present disclosure should not be determined solely by the described embodiments.

The scope of the present disclosure should be determined by the technical idea described in the claims. In addition, even if the actions or effects according to the configuration are not explicitly described while describing the embodiments of the present disclosure, it is obvious that the actions or effects that can be predicted by the corresponding configuration should naturally be recognized as the present disclosure.

1. A manufacturing method of an aluminum-coated steel sheet, comprising:
preparing a plurality of aluminum (Al) scraps;
manufacturing an ingot using the plurality of Al scraps;
coating a base steel using the ingot; and
processing a coated steel sheet.

2. The manufacturing method of an aluminum-coated steel sheet according to claim 1, wherein the plurality of Al scraps contain 9.6 wt % or lower of Si, 1.5 wt % or lower of Fe, 0.9 wt % or lower of Mg, a remainder Al, and other unavoidable impurities.

3. The manufacturing method of an aluminum-coated steel sheet according to claim 1, wherein the manufacturing the ingot comprises:
melting the plurality of Al scraps; and
refining the plurality of Al scraps.

4. The manufacturing method of an aluminum-coated steel sheet according to claim 1, wherein in the manufacturing of the ingot, the ingot containing 8.9 to 9.6 wt % of Si, 1.3 wt % or lower of Fe, 0.7 wt % or lower of Mg, a remainder Al, and other unavoidable impurities is manufactured.

5. The manufacturing method of an aluminum-coated steel sheet according to claim 1, wherein the coating of the base steel comprises:
thermally treating the base steel;
immersing the base steel in a coating bath; and
cooling a coated steel sheet;
wherein the coating bath is manufactured from the ingot.

6. The manufacturing method of an aluminum-coated steel sheet according to claim 5, wherein the coating bath contains 8.9 to 9.6 wt % of Si, 1.3 wt % or lower of Fe, 0.7 wt % or lower of Mg, a remainder Al, and other unavoidable impurities.

7. The manufacturing method of an aluminum-coated steel sheet according to claim 5, wherein thermally treating the base steel is performed at a temperature of 700° C. to 850° C.

8. The manufacturing method of an aluminum-coated steel sheet according to claim 5, wherein a temperature of the coating bath is 630° C. to 680° C.

9. The manufacturing method of an aluminum-coated steel sheet according to claim 5, wherein the cooling is performed at a cooling rate of 3° C./s to 20° C./s.

10. The manufacturing method of an aluminum-coated steel sheet according to claim 1, wherein during processing of the coated steel sheet, hot stamping is performed on the coated steel sheet.

11. The manufacturing method of an aluminum-coated steel sheet according to claim 1, wherein processing of the coated steel sheet is performed at a temperature of 860° C. to 960° C.

12. An aluminum-coated steel sheet, comprising:
a base steel; and
a coating layer formed on the base steel;
wherein the coating layer contains 8.9 to 9.6 wt % of Si, 1.3 wt % or lower of Fe, 0.7 wt % or lower of Mg, a remainder Al, and other unavoidable impurities.

13. The aluminum-coated steel sheet according to claim 12, wherein the other unavoidable impurities are contained in an amount of 0.2 wt % or lower.

14. The aluminum-coated steel sheet according to claim 12, wherein the coating layer is formed from an aluminum (Al) scrap ingot.

15. The aluminum-coated steel sheet according to claim 14, wherein the Al scrap ingot contains 9.6 wt % or lower of Si, 1.5 wt % or lower of Fe, 0.9 wt % or lower of Mg, a remainder Al, and other unavoidable impurities.

16. A hot stamping product comprising the aluminum-coated steel sheet according to claim 12.
